(19) United States
(12) Patent Application Publication
(10) Pub. No.: US 2005/0223359 A1
(43) Pub. Date: Oct. 6, 2005

(54) Techniques for multi-core debugging

(76) Inventors: Kodalapura Nagabhushana Rao Nagaraju, Bangalore (IN); Kasturi Sanyasi Raju Narayana Murthy, Bangalore (IN)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/812,836

(22) Filed: Mar. 30, 2004

(51) Int. Cl. G06F 9/44

(52) U.S. Cl. 717/124

(57) ABSTRACT

Methods, systems, and apparatus are provided for multi-core debugging. A single processor having multiple processing cores dynamically and simultaneously establishes multiple debugging sessions on different ones of the processing cores. Existing applications not associated with the debugging sessions are maintained and processed without interruption and existing states associated with the processor and the processing cores are maintained before and after the debugging sessions are established.

### TECHNICAL FIELD

Embodiments of the present invention relate generally to debugging, and more particularly to techniques for managing multiple debugging sessions for a multi-core processing environment.

### BACKGROUND INFORMATION

Debugging is a crucial task when developing software, developing firmware, and ensuring the proper operation of hardware. During a debugging session variables, resources, and logic may be stepwise inspected for detecting errors or for correcting performance bottlenecks.

Today's microprocessor architectures are often designed with multiple independent processing cores. These cores are processing engines capable of processing instructions independent or in concert with one another. These types of architectures are referred to as multi-core architectures. Thus, a multi-core processing architecture is logically a single processor having multiple independent processing engines (cores).

Conventionally, when a debugging session is established with a multi-core processing architecture, only a single debugger may be attached or initialized within the processor at a given time. The single debugger is initialized or attached to all processing cores of the processor. Moreover, even if the debugger is not attempting to debug certain applications on a specific processing core, the debugger will impact those non-targeted applications. This is so, because when a conventional processor attaches a debugger, that debugger is attached to all the processing cores, such that each processing core is set to break mode in order to attach to and initialize within the processor. Thus, all applications executing on the processor are impacted and suspended in order to accommodate an attachment and an initialization of a single debugger.

Correspondingly, conventional techniques are not optimal, are wasteful of resources, and are extremely inconvenient to users who are relying on stable applications to process on a processing core and which are inconveniently stalled to accommodate a single debugger associated with a single application which are not relevant to users or their stable applications.

Therefore, there is a need for improved debugging techniques within multi-core processing architectures, which are more flexible and less intrusive than what has been available with conventional approaches.

### BRIEF DESCRIPTION OF THE DRAWINGS

FIG. 1 is a flowchart of a method for dynamically and concurrently establishing multiple debugging sessions on a single processor, according to an embodiment of the invention.

FIG. 2 is a flowchart of a method for dynamically attaching multiple debuggers to a single processor, according to an embodiment of the invention.

FIG. 3 is a diagram of a multi-core debugging system, according to an embodiment of the invention.

FIG. 4 is a diagram of a multi-core debugging apparatus, according to an embodiment of the invention.

### DESCRIPTION OF THE EMBODIMENTS

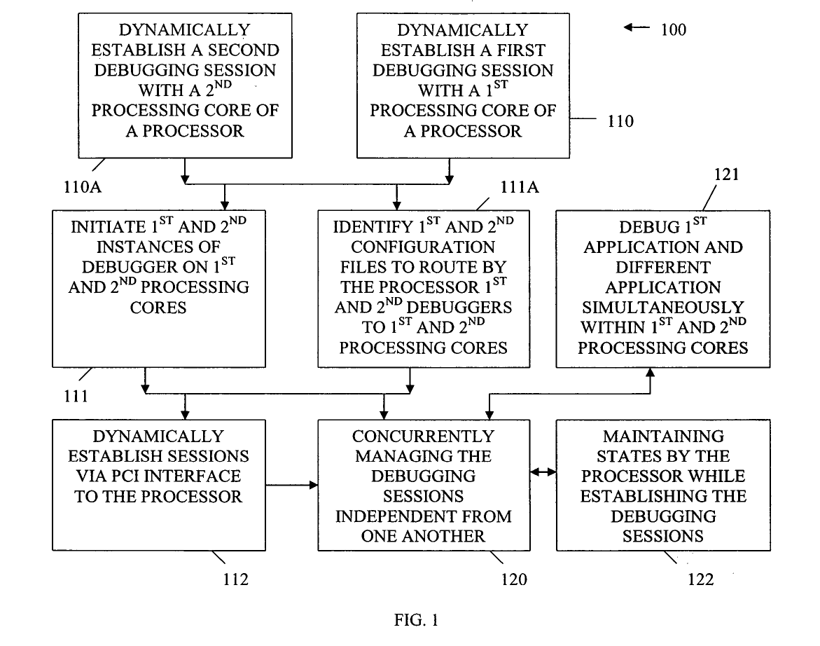

FIG. 1 is an embodiment of a method 100 to dynamically and concurrently establish multiple debugging sessions on a single processor. The method 100 is implemented in a machine accessible medium. In an embodiment, the method 100 is one or more software applications and control information that is processed on a processor, which has multiple processing cores (engines). The initial request to establish the debugging sessions may be communicated from a remote device to the processor. The remote device may communicate an initial debugging session request via other intermediate devices or networks (hardwired, wireless, or combination of hardwired and wireless).

At 110 and 110A, first and second debugging sessions are dynamically established with first and second processing cores of the same processor. A debugging session is a period of time during which a debugger is active and executing within a processing core (engine) of a multi-core processor. During a debugging session, a user interacts with a debugger for purposes of inspecting memory, resources, variables, and logic being used and manipulated by an executing software application (or firmware application), which is being debugged by the debugger. A debugging session may be established by initiating or loading an instance of a debugger within a processing core. The first and second debugging sessions may be dynamically established in any order. That is the first debugging session may be established before the second debugging session at 110, or alternatively, the second debugging session may be established before the first debugging session at 110A.

In an embodiment, the processor includes a plurality of processing cores (engines). Thus, the processor associated with embodiments of this invention is referred to as a multi-core processor architecture. The processor dynamically establishes first and second debugging sessions with first and second processing cores in a variety of ways. For example, at 111, a debugger instance is initiated or loaded to a defined processing core within the processor, by using a loader. The loader locates the instructions for the debugger and assigns a unique identification to the instructions (unique instance of the debugger) and causes the instructions to be loaded into memory and processed on the desired processing core. It should be noted that the processor may include more than two processing cores. In this way, the first and second processing cores are presented herein only for purposes of illustration and are not intended to restrict embodiments to just first and second processing cores, since any number of processing cores greater than two are possible with embodiments of the invention.

The processor may determine with which processing cores the first and second debugging sessions are to be associated. For example, in an embodiment, the processor's loader determines, based on its configuration, as to which specific processing core that a specific debugging session is to be established. In another embodiment, the processor's loader determines the appropriate processing cores based on configuration files, at 111A, which accompany requests for the debugging sessions. In some embodiments, the configuration files are merely configuration parameters which accompany requests for establishing the debugging sessions, where the parameters identify the desired processing cores of the processor, and where the debugging sessions are to be established.

A debugging request is a command issued to the processor for loading and starting the execution of a debugger. In an embodiment, this request, and the resulting debugging sessions produced by the processor's loader, may be communicated from remote devices to the processor; such remote devices may communicate with the processor via a Peripheral Component Interconnect (PCI) interface as depicted at 112.

Once first and second debugging sessions are established on first and second processing cores, respectively, the debugging sessions are concurrently managed and simultaneously executed on their respective processing cores within the same processor at 120. Thus, in an embodiment, at 121, a first application associated with the first debugging session may be debugged on the first processing core while a different application associated with the second debugging session is debugged on the second processing core.

At 122, the states associated with the processor and its processing cores are maintained before and after each of the debugging sessions are dynamically established. Thus, the processor's loader or attachment logic does not issue a traditional break operation within its processing cores when an instance of a debugger is being loaded; rather, prior states are maintained and saved as instances of the debugger are loaded and restored after the load has successfully occurred. Moreover, if first and second instances of a debugger are being loaded to first and second processing cores for establishing first and second debugging sessions, then a third or fourth processing core need not be impacted at all with these activities and may continue processing its applications uninterrupted.

With existing systems, only a single debugging instance is actively executed within a multi-core processor; and this single instance causes the interruption (break mode) of all activities executing on all processing cores during a load process. This is an inefficient use of processing resources and results in excessive time delays associated with software or firmware development.

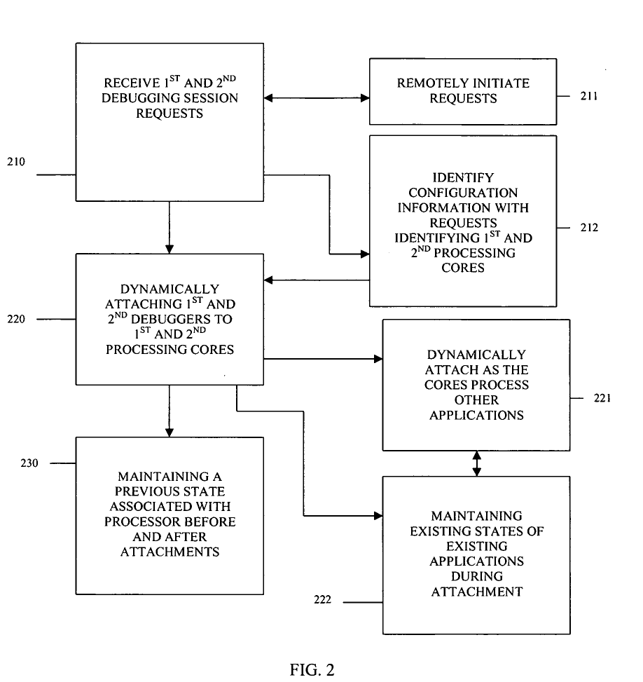

FIG. 2 is an embodiment of one method 200 for dynamically attaching multiple debuggers to a single processor. The method 200 is implemented within a machine accessible medium. In an embodiment, the method 200 is implemented as a generic debugger loader associated with the processor. The method 200 may be installed on the processor as firmware which is distributed with the processor. Alternatively, the method 200 may be loaded to the processor after the processor is distributed. The initial loading of the method 200 to the processor may be achieved by acquiring the method 200 from removable machine readable medium interfaced to the processor, from storage devices interfaced to the processor, or from a remote service networked from a remote location to the processor (e.g., remote World-Wide Web (WWW) site via the Internet).

In an embodiment, the processor executes the instructions associated with the method 200, and the processor is a multi-core processor architecture, which means that the processor includes two or more processing cores (engines). Other devices and peripheral devices may interact with the processor via data buses, hardwired connections, wireless connections, or combinations of the same.

At 210, first and second debugging requests are received, these requests are received from other devices (e.g., storage, etc.) and are associated with initiating instances of a debugger within the processor for purposes of establishing debugging sessions and debugging applications which executes within that processor. In an embodiment, these requests are remotely initiated and transmitted to the processor via another device, such as a PCI interface, as depicted at 211. The requests are commands that instruct the processor to load instances of a debugger within the processor for execution.

In an embodiment, at 212, the requests are accompanied by configuration information. The configuration information identifies specific processing cores which the requests want the processor to load an instance of a debugger. The configuration information may be a parameter associated with a command to load a debugger instance, where that parameter identifies a specific processing core. Alternatively, the configuration information may be a file name, which the processor references to acquire the identity of a specific processing core for which a debugger instances is to be loaded.

The configuration information, in some embodiments, is preconfigured within memory or storage associated with the processor. In other embodiments, the configuration information is provided with the requests to the processor. In yet more embodiments, the configuration information are identified by the requests sent to the processor, and the processor acquires the configuration information when needed.

After the requests are received for first and second debugging sessions at 210, the method 200 processes the requests at 220 in order to dynamically attach a first debugger instance and a second debugger instance to first and second processing cores, respectively. The term “attach” means that the method 200 loads the instructions associated with a debugger instance into memory associated with an appropriate one of the processing cores for execution.

The method 200 does not interrupt (e.g., break mode) the processing that is occurring within the processing cores when a request for establishing a debugging session is received. The method 200 performs a load without changing or altering the states associated with other applications that are processing on the processing cores when a debugging session is established by loading an instance of a debugger. Thus, in an embodiment, at 221, the first debugger and second debugger are dynamically attached (loaded) to their respective processing cores while other applications continue to process within one or more of those processing cores.

Additionally, in some embodiments, the requests for the first and second debugging sessions are for different debuggers. The first request for a first debugging session results in a first debugger being dynamically attached or loaded in a first processing core while the second request for a second debugging session results in a second and different debugger being dynamically attached or loaded in a second processing cores. As was described in detail above, and in some other embodiments, the first and second debuggers are actually the same debugger that is loaded as separate processing instances within two separate processing cores.

Furthermore, the method 200 dynamically attaches the first and second debuggers to their respective processing cores while maintaining the existing states of any existing applications that are processing on those or other processing cores of the processor at 222. Conventionally, this was not done, in fact states of all applications processing on a multi-processor architecture where broken to load and attach a single debugger for a single debugging session. Moreover, and traditionally, a multi-processor architecture was only capable of maintaining a single active debugging session at a time. These limitations have been eliminated with the embodiments of this invention.

At 230, the first and second debuggers are dynamically attached to their respective processing cores while a previous state associated with the processor is maintained before and after the attachments. The overall state of the processor is maintained as the dynamic attachments (loads) occur within the appropriate processing cores of the processor.

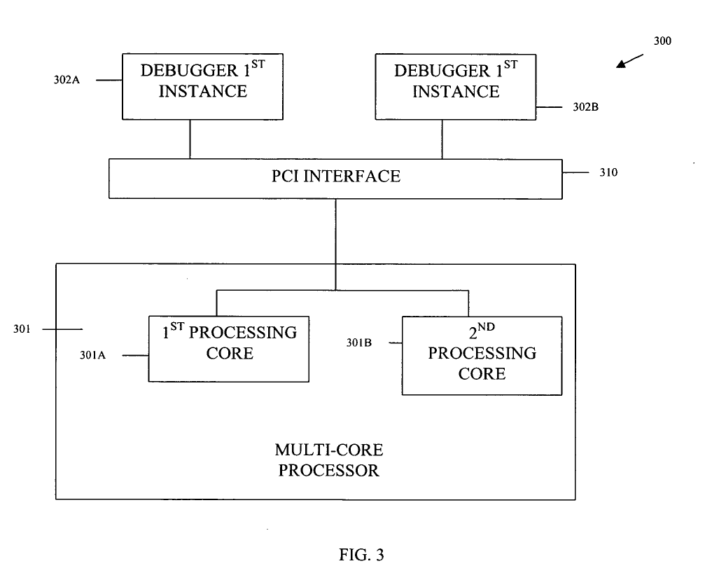

FIG. 3 is a diagram of one multi-core debugging system 300. The multi-core debugging system 300 is implemented in a machine accessible or readable medium. The multi-core debugging system 300 implements the methods 100 and 200 of FIGS. 1 and 2, respectively. The multi-core debugging system 300 may be prefabricated with the processing of methods 100 and 200 or may be subsequently configured with the processing of the methods 100 and 200. In an embodiment, the multi-core debugging system 300 is embedded in a device, such as a computer, a server, an intelligent appliance, a personal digital assistant, a phone, a navigation device, a transportation vehicle, a television, and others.

The multi-core debugging system 300 minimally includes a multi-core processor 301 having a first processing core 301A and a second processing core 301B. The processor 301 once configured also includes a first debugging instance 302A and a second debugging instance 302B, such that the first debugging instance 302A is attached or loaded for execution within the first processing core 301A and the second debugging instance 302B is attached or loaded for execution within the second processing core 301B. Attachment occurs dynamically while other applications continue to execute within the processor 301 and its processing cores 301A-301B.

In an embodiment, the instructions associated with the first debugger instance 302A and the second debugger instance 302B are communicated to the processor 301 from an external or remote device (e.g., remote storage, memory, etc.). In an embodiment, those remote devices housing the instructions of the debugger instances 302A-302B are communicated to the processor 301 via a PCI interface 310. Of course, in other embodiments other interfaces may be used; those other interfaces may be hardwired or wireless or a combination of hardwired and wireless.

During operation of the multi-core debugging system 300, the processor 301 receives commands or requests from remote devices to attach or load a first debugging instance 302A and a second debugging instance 302B in the processor's first and second processing cores 301A-301B, respectively. A loader associated with the processor 301 (e.g., method 100 or method 200 of FIGS. 1 and 2, respectively) determines how to route the requests and load the debugging instances 302A-302B.

One technique for determining which debugging instance 302A-302B is loaded or attached within which processing core 301A-301B, is to associate a configuration file or configuration information with each of the initial requests or as combined information associated with both requests. The configuration file or information identifies a specific one of the processing cores 301A or 301B.

In some embodiments, the configuration information is directly associated with or included with each request for attaching a specific debugger instance 302A or 302B. In other embodiments, the configuration file name is supplied with each request and referenced for acquiring the needed identity of a specific processing core 301A or 301B. In yet other embodiments, the configuration file or information is independent of the received request and is accessible to or managed by the loader of the processor 301, such that the loader randomly determines an appropriate processing core 301A or 301B, deterministically determines an appropriate processing core 301A or 301B based on existing processing loads associated with the processing cores 301A-301B, or deterministically determines an appropriate processing core 301A or 301B based on some other configured logic associated with the loader.

Once the first and second debugging instances 302A-302B are attached or loaded within their respective processing cores 301A-301B, first and second debugging sessions are established. During these sessions interactions occur between user(s) and the debugging instances 302A-302B for purposes of inspecting resources, variables, and logic associated with executing applications. In some embodiments, the sessions are associated with entirely different executing applications being inspected by entirely different users or developers. Each session operates independent of the remaining session and both sessions may proceed simultaneously within the processor 301. This is an improvement over conventional debugging techniques, where a conventional multi-core processor is only capable of maintaining a single active debugging session at a time.

Further, before and after the first and second debugging instances 302A-302B are dynamically attached or loaded to their respective processing cores 301A-302B, previous or existing states of the processor 301 and the processing cores 301A-301B are maintained. This permits applications not associated with the debugging sessions to continue to execute and processing with the processor 301 without being broken. Again, this is an improvement over conventional debugging techniques, because with conventional approaches when a single debugging session is established, all existing applications are broken and interrupted in order for the debugging session to process within the conventional multi-core processor. This is no longer the case with the teachings presented herein.

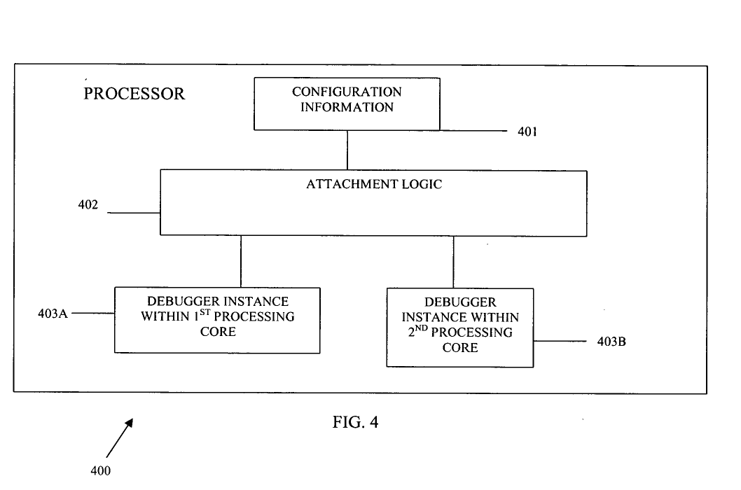

FIG. 4 is a diagram of one multi-core debugging apparatus 400. The multi-core debugging apparatus 400 is implemented in a machine accessible or readable medium. In an embodiment, the multi-core debugging apparatus 400 is fabricated or installed within a processor. The multi-core debugging apparatus 400 may be fabricated when the logic associated with the multi-core debugging apparatus 400 is firmware. The multi-core debugging apparatus 400 is installed by loading software instructions into the processor for execution. That installation may occur by acquiring the software instructions from storage, memory, a removable computer readable medium, or a remote service or storage device interfaced to the processor over a network connection. The network connection may be hardwired, wireless, or a combination of hardwired and wireless.

The multi-core debugging apparatus 400 includes configuration information 401, attachment or loading logic 402, and a first debugging instance 403A within a first processing core and a second debugging instance 403B within a second processing core. The first and second processing cores are associated with the same multi-core processor.

The attachment logic 402 processes requests for debugging sessions by determining which processing cores to attach or load debugging instances 403A and 403B and by effectuating those attachments or loads. The attachment logic 402 makes these determinations based on the configuration information 401. The configuration information 401 may be received with requests for the debugging session or may exist as preconfigured information within the processor that houses the attachment logic 402. In an embodiment, the configuration information 401 is parameter data passed with debugging session requests from external devices to the processor. That parameter data identifies a specific processing core, which the attachment logic 402 uses to attach a specific instance of a debugger 403A or 403B to that specific processing core. In still other embodiments, the configuration information is one or more files associated with the debugging instances 403A and 403B, which the attachment logic 402 may reference to resolve which processing core should receive and load which of the debugging instances 403A or 403B.

The attachment logic 402 also ensures that when the debugging instances 403A and 403B are attached or loaded the state of the processor and the processing cores remains unchanged. Thus, existing applications processing within the processor may continue to execute and each of the debugging instances 403A and 403B may execute concurrently with one another.

The attachment logic 402 and the configuration information 401 when fabricated or installed within a multi-core processor permit that multi-core processor to dynamically attach or load multiple debugging instances 403A and 403B to multiple processing cores without altering the execution or other processing applications and without altering the states of that processor.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which such claims are entitled.

The Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method, comprising:
dynamically establishing a first debugging session with a first processing core of a processor;
dynamically establishing a second debugging session with a second processing core of the same processor; and
concurrently managing the first and second debugging sessions independently from one another on the same processor.

2. The method of claim 1, further comprising:
initiating a first instance of a debugger on the first processing core of the processor for interactions occurring during the first debugging session; and
initiating a second instance of the debugger on the second processing core of the processor for interactions occurring during the second debugging session.

3. The method of claim 1, wherein dynamically establishing the first and second debugging sessions further comprises dynamically establishing the sessions by connecting the first and second processing cores of the processor to separate instances of a debugger via a Peripheral Component Interconnect (PCI) interface.

4. The method of claim 1, further comprising:
debugging a first application within the first debugging session on the first processing core of the processor; and
simultaneously debugging a second application within the second debugging session on the second processing core of the processor.

5. The method of claim 1, further comprising:
identifying within a first configuration file of a first debugger the first processing core associated with the first debugging session; and
identifying within a second configuration file of a second debugger the second processing core associated with the second debugging session.

6. The method of claim 5, further comprising:
routing, by the processor, the first debugger to the first processing core for establishing the first debugging session based on the first configuration file; and
routing, by the processor, the second debugger to the second processing core for establishing the second debugging session based on the second configuration file.

7. The method of claim 1, further comprising maintaining, by the processor, processor states while dynamically establishing the first and second debugging session.

8. A method, comprising:
receiving, by a processor, a first debugging session request;
receiving, by the processor, a second debugging session request;
dynamically attaching a first debugger to a first processing core for servicing the first debugging session request; and
dynamically attaching a second debugger to a second processing core for servicing the second debugging request.

9. The method of claim 8, wherein dynamically attaching the first and second debuggers further includes identifying the first and second debuggers as a same debugger being initiated as independent and duplicative instances on different processing cores.

10. The method of claim 8, further comprising identifying within the first and the second debugging session requests configuration information which identifies the first and second processing cores.

11. The method of claim 8, wherein dynamically attaching the first and second debuggers further includes maintaining a previous state associated with the processor of the first and second processing cores before and after attaching the first and second debuggers to their respective processing cores.

12. The method of claim 8, wherein receiving the first and second debugging session requests further includes remotely initiating the requests from the processor that has the first and second processing cores.

13. The method of claim 8, further comprising maintaining existing states associated with existing applications, the existing applications processing on the first and second processing cores before and after dynamically attaching the first and second debuggers to the first and second processing cores, respectively.

14. The method of claim 8, wherein dynamically attaching the first and second debuggers further includes attaching the first and second debuggers to their respective processing cores as their respective processing cores are processing a number of other applications.

15. A system, comprising:
a processor having a first processing core and a second processing core; and
a debugger, wherein a first instance of the debugger is dynamically attachable to the first processing core of the processor and a second instance of the debugger is dynamically attachable to the second processing core of the processor.

16. The system of claim 15, further comprising a Peripheral Component Interconnect (PCI) interfaced to the processor for receiving requests to dynamically attach the first and second debugger instances to their respective processing cores.

17. The system of claim 15, further comprising a first configuration file associated with the first debugging instance and a second configuration file associated with the second debugging instance, wherein each configuration file identifies its respective processing core, and wherein the processor in response to the configuration files dynamically attaches the debugger instances to their respective processing cores.

18. The system of claim 15, wherein the first debugging instance establishes a first debugging session for debugging a first application and the second debugging instance establishes a second debugging session for debugging a second application, and wherein the first and second applications are different from one another.

19. The system of claim 15, wherein the processor maintains states associated with the first and second processing cores before and after the first and second instances are dynamically attached to their respective processing cores.

20. A machine accessible medium having associated instructions, which when accessed, results in a machine performing:
receiving a first request for a first debugging session;
receiving a second request for a second debugging session;
dynamically establishing the first debugging session on a first processing core; and
dynamically establishing the second debugging session on a second processing core.

21. The medium of claim 20, further including instructions for concurrently managing the first and second debugging sessions independent from one another on a processor having the first and second processing cores.

22. The medium of claim 20, further including instructions for initiating a first debugger instance on the first processing core for managing the first debugging session and a second debugger instance on the second processing core for managing the second debugging session.

23. The medium of claim 20, further including instructions for maintaining states of the first and second processing cores before and after the first and second debugging sessions are dynamically established on their respective processing cores.

24. The medium of claim 20, further including instructions for actively and simultaneously debugging a first application within the first debugging session and a different application within the second debugging session.

25. An apparatus, comprising:
configuration information associated with instances of a debugger; and
attachment logic residing within a processor having multiple processing cores that dynamically attaches selective ones of the instances of the debuggers to selective ones of the processing cores in response to requests for debugging sessions having the configuration information.

26. The apparatus of claim 25, wherein the attachment logic maintains states of the processing cores before and after any dynamic attachment of the instances of the debugger.

27. The apparatus of claim 25, wherein configuration information is configurable parameter values provided with the requests for debugging sessions.

28. The apparatus of claim 25, wherein the configuration information is files, where each file is associated with a unique one of the debugging instances.
